(19) United States
(12) Patent Application Publication
(10) Pub. No.: US 2007/0041860 A1
(43) Pub. Date: Feb. 22, 2007

(54) Rotary vane air pump

(76) Inventors: Tatsuya Nakamoto, Kusatsu-shi (JP); Kiyoshi Sawai, Otsu-shi (JP); Atsushi Sakuda, Ritto-shi (JP)

Correspondence Address: WENDEROTH, LIND & PONACK L.L.P., 2033 K. STREET, NW, SUITE 800, WASHINGTON, DC, 20006, US

(21) Appl. No.: 10/559,388

(22) PCT Filed: Jun. 7, 2004
(86) PCT No.: PCT/JP04/08244

§ 371 Date: Oct. 4, 2006

(30) Foreign Application Priority Data
Jun. 11, 2003 (JP) 2003-166377

(51) Int. Cl. F01C 19/02; F04C 27/00; F04C 15/00; F03C 2/00

(52) U.S. Cl. 418/123; 418/124; 418/112

(57) ABSTRACT

At least one of a cylinder (6), a rotor (8), a front plate (14), and a rear plate (16), all of which form compression chambers (18), is made of a metal, and a surface treatment is conducted on a portion of such at least one of those members.

### TECHNICAL FIELD

The present invention relates to a construction of an oil-free rotary vane air pump which is employed in an air supply device for a mobile information terminal device employing a fuel cell therein and in which no lubricating oil is used.

### BACKGROUND ART

FIGS. 4 and 5 depict a conventional oil-free rotary vane pump including a cylinder 103 that has a cylindrical inner wall, opposite ends of which are closed by a front plate 111 and a rear plate 112, respectively. The cylinder 103 accommodates therein a rotor 107 having an outer peripheral surface of which a specific region is always spaced away from the inner wall of the cylinder 103 to define a small space therebetween.

The rotor 107 includes a rotary shaft 110 secured thereto for rotation together therewith, and the rotary shaft 110 is rotatably supported by a ball bearing 116 mounted on the front plate 111 and by a ball bearing 118 mounted on the rear plate 112. The rotor 107 has a plurality of vane slits 108 defined therein and a plurality of plate-shaped vanes 109 made of a material having self-lubricating properties with one end of each of the plate-shaped vanes 109 slidably received in one of the vane slits 108. The vanes 109 form a plurality of compression chambers 104 together with the cylinder 103, the rotor 107, the front plate 111, and the rear plate 112. The cylinder 103 has a suction port 113 and a discharge port 114 both defined therein so as to each communicate with one of the compression chambers 104.

In the rotary vane pump of the above-described construction, when a drive force of a driving source such as, for example, an electric motor (not shown) is transmitted to the rotary shaft 110, the rotor 107 rotates together with the rotary shaft 110 to thereby suck a fluid into the compression chambers 104 through the suction port 113. The fluid so sucked is then compressed within the compression chambers 104 and subsequently discharged from the discharge port 114 (see, for example, patent Document 1).

In applications where a material having self-lubricating properties is used for the vanes 109, it is a common practice that the cylinder 103, the rotor 107, the front plate 111, and the rear plate 112, with all of which the vanes 109 are held in sliding contact, are made of a metallic material.

Further, in the conventional vane compressors, at least one of various surface treatments is conducted on the metallic material (see, for example, patent Documents 2 to 4).

However, the pumps and compressors referred to above premise oil lubrication, and the surface treatments are intended for enhancing the wear and abrasion resistance.
Patent Document 1: Japanese Laid-Open Patent Publication No. 6-185484
Patent Document 2: Japanese Laid-Open Patent Publication No. 2-136586
Patent Document 3: Japanese Laid-Open Patent Publication No. 64-73185
Patent Document 4: Japanese Laid-Open Patent Publication No. 63-28891

In the conventional rotary vane pumps referred to above, when air having a high humidity enters the compression chambers 104, and the pump is kept stopped for a long period of time, the vanes 109 are, in some cases, stuck and cannot slide within the vane slits 108 due to rust produced within the vane slits 108. If sliding movement of the vanes 109 is not allowed, they collide with the cylinder 103 and the rotor 107 can no longer rotate, thus disabling operation of the pump. Even if the operation of the pump is possible, rust produced on the front plate 111, the rear plate 112, the cylinder 103, and the rotor 107 at locations facing the compression chambers 104 becomes a resistance to the operation of the pump to thereby reduce the frequency of operation. As a result, there arises a problem in that the discharge rate reduces, while an input to the motor increases.

In applications where a surface treatment is conducted on the front plate 111, the rear plate 112, the cylinder 103, and the rotor 107 facing the compression chambers 104 for rust prevention, the surface of the cylinder 103 becomes rough after the surface treatment depending on the kind of surface treatment. As a result, there arises a problem in that sounds, which would be generated during sliding movement between the inner surface of the cylinder 103 and end portions of the vanes 109, become larger after the surface treatment than before the surface treatment.

Also, in the conventional vane compressors, even if the surface treatment is worn due to sliding movement and a ground material is exposed, the presence of oil causes no sticking or seizing. In addition, because such vane compressors are generally used in a closed cycle, and no moisture enters from outside, the exposed ground material does not corrode. By contrast, oil-free pumps encounter such a problem that once the surface treatment is worn, the exposed ground material corrodes.

The present invention has been developed to overcome the above-described disadvantages.

It is accordingly an objective of the present invention to provide a rotary vane air pump that can prevent rust from being produced within the compression chambers, and can be operated with reduced noises without reducing its performance even when air having a high humidity enters.

### DISCLOSURE OF THE INVENTION

In accomplishing the above and other objectives, the oil-free rotary vane air pump according to the present invention includes a pump mechanism and a drive motor juxtaposed with each other. The pump mechanism includes a cylinder having a cylindrical inner wall that is eccentric with respect to a longitudinal axis of the cylinder, a cylindrical rotor accommodated within the cylinder and having a plurality of vane slits defined therein, a rotary shaft that rotates together with the rotor, a plurality of plate-shaped vanes made of a material having self-lubricating properties, each of the plurality of plate-shaped vanes being slidably received in one of the plurality of vane slits, and front and rear plates mounted on opposite end surfaces of the cylinder, respectively, with the rotor and the vanes interposed therebetween, thereby forming a plurality of compression chambers in the pump mechanism. The rotary shaft is driven by the drive motor to change a volume of each of the compression chambers. A clearance is provided between the rotor and the front plate and between the rotor and the rear plate so as not to allow a sliding contact. At least one of the cylinder, the rotor, the front plate, and the rear plate is made of a metal, and a surface treatment is conducted on a portion of such at least one of the cylinder, the rotor, the front plate, and the rear plate, which portion faces the compression chambers.

According to the present invention, because the surface treatment is conducted on the metallic material portions facing the compression chambers, even if air having a high humidity enters the compression chambers, the adhesion of moisture to the metallic surfaces is avoided, making it possible to prevent the production of rust and prevent pump locking in which operation of the pump is no longer possible or lowering of the frequency of operation.

If one or a combination of anodic oxide coating, Ni—P plating coating, and PTFE coating is conducted on the metallic material portions, wear of the surface coating due to a sliding movement of the vanes relative thereto considerably reduces, compared with tinning or DLC (Diamond Like Carbon: hard carbon film of an amorphous material mainly composed of carbon and hydrogen). Accordingly, the surface coating remains even after the long term use, making it possible to prevent the production of rust.

Further, if PTFE coating that is superior in self-lubricating properties is conducted on the front plate and the rear plate at their surfaces facing the compression chambers, the coefficient of friction between the end surface of the rotor and the front plate or the rear plate reduces, making it possible to prevent lowering of the frequency of operation or the discharge rate and prevent the production of rust while reducing the input.

If the rotor is made of aluminum and conduced with an anodic oxidation treatment that provides a hard coating and is resistant to wear, it is advantageous in terms of cost and the surface coating remains even after the long term use, making it possible to prevent the production of rust.

In addition, if Ni—P plating coating is conducted on an inner surface of the cylinder, such surface becomes smooth after the treatment. If a lapping treatment is additionally conducted on the surface-treated portion, it is improved in surface roughness, making it possible to reduce sounds that would be mainly produced between the distal end portions of the vanes and the inner surface of the cylinder.

### BRIEF DESCRIPTION OF THE DRAWINGS

FIG. 1 is a vertical sectional view of a rotary vane air pump according to the present invention.

FIG. 2 is a section taken along line II-II in the rotary vane air pump of FIG. 1.

FIG. 3 is a graph depicting relationships between the kind of surface treatments conducted on the cylinder inner surface and the noise level, surface roughness, or surface hardness.

FIG. 4 is a vertical sectional view of a conventional rotary vane pump.

FIG. 5 is a section taken along line V-V in the conventional rotary vane pump of FIG. 4.

### DETAILED DESCRIPTION OF THE PREFERRED EMBODIMENT

A preferred embodiment of the present invention is discussed hereinafter with reference to the drawings.

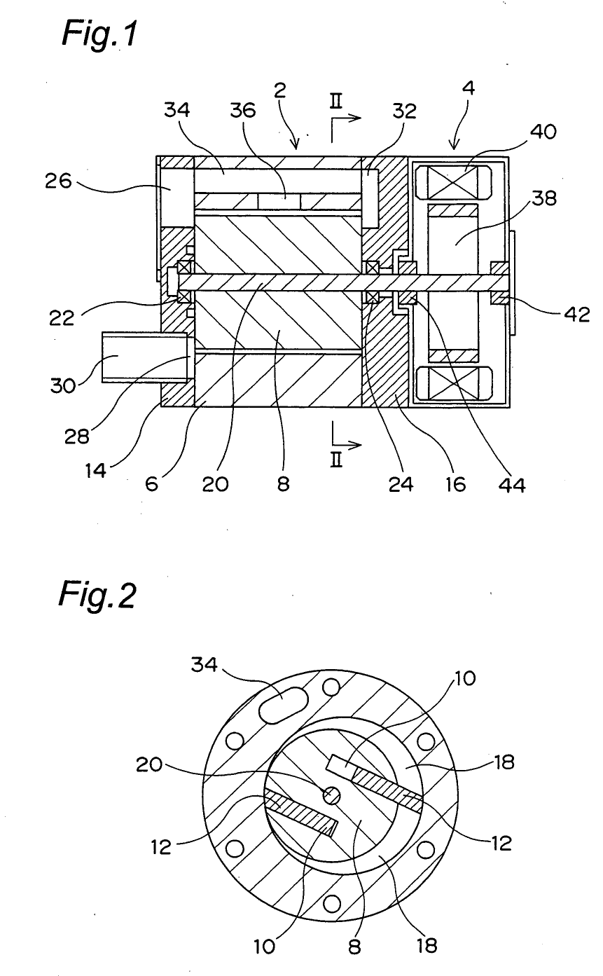

FIGS. 1 and 2 depict a rotary vane air pump according to the present invention, which includes a pump mechanism 2 and a drive motor 4 such as, for example, a DC motor juxtaposed with each other.

The pump mechanism 2 includes a cylinder 6 made of a metal such as, for example, aluminum and having a cylindrical inner wall formed eccentrically with respect to a longitudinal axis of the cylinder 6 or with respect to a rotation center of a generally cylindrical rotor 8 accommodated therein. The rotor 8 has a plurality of vane slits 10 defined therein so as to extend approximately towards a central axis thereof. A plate-shaped vane 12 made of a material such as carbon or the like having self-lubricating properties is slidably received in each of the vane slits 10, and no lubricating oil is used. A front plate 14 and a rear plate 16 are mounted on opposite end surfaces of the cylinder 6, respectively, and the vanes 12 are interposed therebetween to define a plurality of compression chambers 18 within the cylinder 6. The front plate 14 and the rear plate 16 are also made of a metal such as, for example, aluminum. Those portions of the metallic materials that face the compression chambers 18 are conducted with a surface treatment discussed later in detail.

To the rotor 8 is connected a rotary shaft 20 that also serves as a motor shaft of the drive motor 4 located on a side of the rear plate 16 remote from the rotor 8. The rotary shaft 20 extends in alignment with a longitudinal axis of the cylinder 6 and is rotatably supported by a ball bearing 22 press fitted into the front plate 14 and by a ball bearing 24 press fitted into the rear plate 16.

In the practice of the present invention, the vanes 12 are of an oil-free construction and hence made of a material having self-lubricating properties, and a clearance is provided between the rotor 8 and the front plate 14 and between the rotor 8 and the rear plate 16. More specifically, the rotor 8 is rigidly secured to the rotary shaft 20 by press fitting, shrink fitting, bonding or the like so that the clearance may be in the range of 10 μm to 30 μm. A biasing means may be additionally provided to bias the rotor 8 in one direction. A grease-filled bearing superior in lubricity is used for each bearing.

The front plate 14 has a suction port 26 and a discharge port 28 both defined therein, and a discharge pipe or tube 30 is secured to the discharge port 28. The rear plate 16 has a recess 32 defined therein at a location confronting the suction port 26. The suction port 26 and the recess 32 are communicated with each other via a through-hole 34 defined in the cylinder 6 in an axial direction thereof. The through-hole 34 is in turn communicated with the compression chambers 18 one at a time via a communicating opening 36 defined in the cylinder 6 at a central portion thereof.

On the other hand, the drive motor 4 includes a rotor 38 and a stator 40 disposed so as to confront an outer peripheral portion of the rotor 38, and the rotary shaft 20 that also serves as the motor shaft is rotatably supported by a bearing 42 and a bearing 44.

In the rotary vane air pump of the above-described construction, when the stator 40 is supplied with electricity, a magnetic action between the rotor 38 and the stator 40 applies a torque to the rotor 38 to rotate it, and a rotational force of the rotor 38 is transmitted to the pump mechanism 2 via the rotary shaft 20 integral with the rotor 38.

Because the rotor 8 is connected to the rotary shaft 20, the rotor 8 rotates together with the rotary shaft 20. As a result, the vanes 12 slidably received within the vane slits 10 in the rotor 8 slide outwardly towards the inner surface of the cylinder 6 by the action of a centrifugal force thereof so that distal end portions of the vanes 12 may be brought into contact with the inner surface of the cylinder 6 to thereby define the plurality of compression chambers 18 within the cylinder 6. At this time, air sucked through the suction port 26 in the front plate 14 enters the compression chambers 18 via three passageways, i.e., a passageway leading directly to the compression chambers 18, a passageway leading to the compression chambers 18 via the through-hole 34 in the cylinder 6 and then via the recess 32 in the rear plate 16, and a passageway leading to the compression chambers 18 via the through-hole 34 and then via the communicating opening 36 in the central portion of the cylinder 6.

The air introduced into the compression chambers 18 is compressed within the compression chambers 18 with the rotation of the rotor 8 and is subsequently discharged from the discharge pipe 30 via the discharge port 28. That is, the rotary vane air pump compresses the air by utilizing volume changes (expansion and contraction) of the plurality of compression chambers 18.

In the rotary vane air pump according to the present invention, because a clearance is provided between the rotor 8 and the front plate 14 and between the rotor 8 and the rear plate 16, the rotor 8 is not brought into sliding contact with any one of the front plate 14 and the rear plate 16. Accordingly, the surface treatment conducted on the front plate 14 and the rear plate 16 is not worn away.

The sliding contact occurs between the vanes 12 and the front plate 14, between the vanes 12 and the rear plate 16, between the vanes 12 and the rotor 8, and between the vanes 12 and the inner surface of the cylinder 6. In each case, only the vanes 12 made of a self-lubricating material are worn away, and the surface treatment conducted on the component parts that are brought into sliding contact with the vanes 12 is not worn away. That is, even in the case where moisture enters from outside, the surface treatment prevents such component parts from rusting, making it possible to maintain the stable performance for a long period of time.

Further, the surface treatment conducted on the portions of both the front plate 14 and the rear plate 16 facing the compression chambers 18 is PTFE coating that is superior in self-lubricating properties. Accordingly, even if an end surface of the rotor 8 or the vanes 12 are, even temporarily, brought into contact with the front plate 14 or the rear plate 16 due to, for example, an abnormal load, the coefficient of friction between the end surface of the rotor 8 and the front plate 14 or the rear plate 16 is relatively small, thus preventing lowering of the frequency of operation and resultant lowering of the discharge rate, and also preventing the production of rust while reducing the motor input.

The surface treatment conducted is explained hereinafter in detail.

In the pump mechanism 2 of the air pump according to the present invention, what are held in sliding contact are only the vanes 12 and, hence, the kind of the surface treatment is appropriately selected in consideration of the sliding conditions of respective portions of the vanes 12, i.e., side end surfaces of the vanes 12 (the surfaces confronting the front plate 14 and the rear plate 16), contact surfaces of the vanes 12 with the vane slits 10, and distal end surfaces of the vanes 12. One of the selection criteria is the noise level during operation, and in this embodiment selection was carried out by comparing noise levels.

As to the side end surfaces of the vanes 12, because a clearance is provided between them and the front plate 14 or the rear plate 16, there is a good chance that when the pump is in operation, the vanes 12 move in the axial direction and collide with them. Accordingly, it is necessary to reduce very small collision sounds that would be generated between the vanes 12 and the front plate 14 or the rear plate 16 and, hence, it is preferred that a surface treatment providing a relatively high hardness or a high sound absorption effect be selected. For this reason, a surface treatment by means of PTFE coating is preferably conducted on the front plate 14 and the rear plate 16.

The rotor 8 is made of aluminum, and anodic oxide coating is conducted on the surface thereof. Although there is a clearance between the vane slits 10 and the vanes 12 received therein, the vanes 12 slide within the vane slits 10 in an inclined state because the rotor 8 rotates in one direction and pressures within the respective compression chambers 18 act on the vanes 12. The vanes 12 slide outwardly or inwardly within the vane slits 10 during rotation, but an edge of an open end of each vane slit 10 is held at a limited region thereof in sliding contact with the associated vane 12. Accordingly, it is preferred that a surface treatment providing a relatively high hardness or a superior wear and abrasion resistance be conducted on the contact surfaces of the vane slits 10. For this reason, a surface treatment by means of anodic oxide coating is preferably conducted on the rotor 8.

The anodic oxide coating can be also uniformly formed on the inner surfaces of the vane slits 10, provides a high hardness and is resistant to wear. Also, the anodic oxide coating can be conducted at a low cost, withstand a long term operation, and prevent rust from being produced for a long period of time.

Lastly, as to the distal end surfaces of the vanes 12, it is preferred that a surface treatment be selected by attaching great importance to the wear and abrasion resistance because a large load acts on the inner surface of the cylinder 6 by the action of a centrifugal force and a back pressure acting on the vanes 12. However, if the inner surface of the cylinder 6 is distorted or rough, the so-called “vane jumping” in which the vanes 12 slide irregularly occurs to thereby increase noises. That is, importance must be also attached to the surface roughness. In order to balance these, it is preferred that a surface treatment by means of nickel plating be conducted on the inner surface of the cylinder 6.

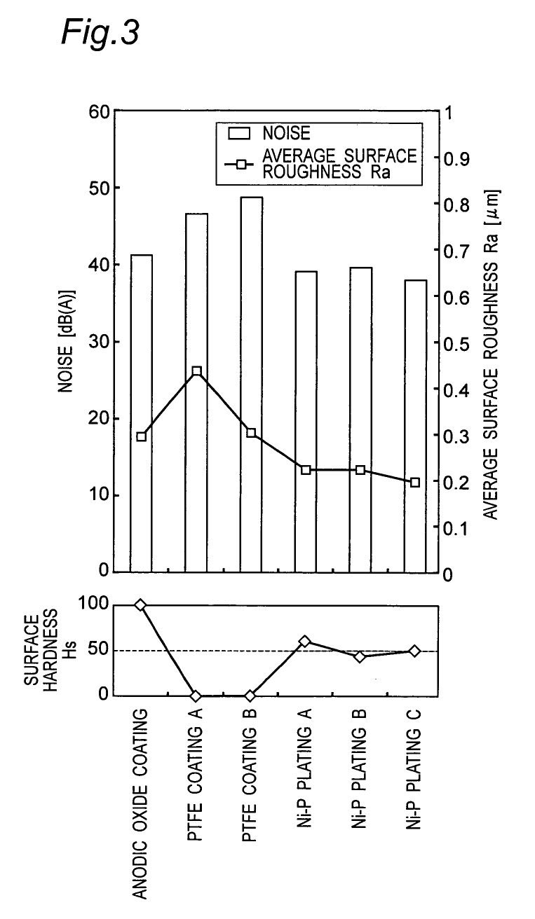

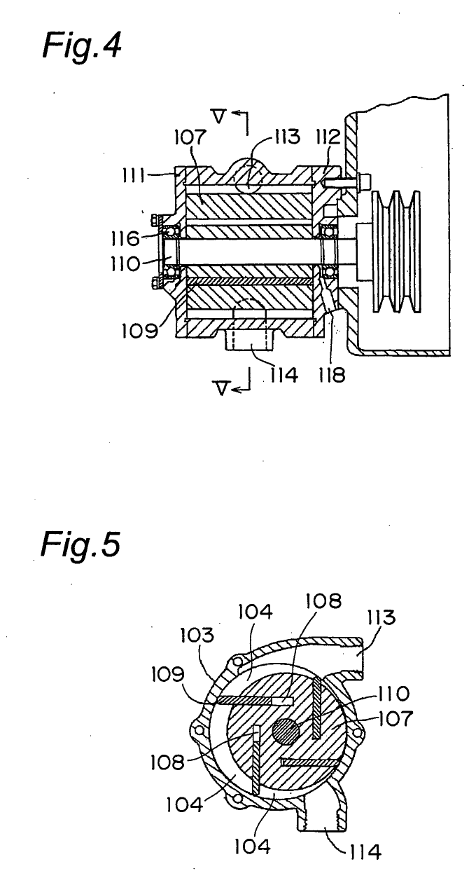

The graph of FIG. 3 indicates noise levels measured when various surface treatments were conducted on the cylinder 6 and also indicates relationships between the kind of surface treatments conducted on the cylinder inner surface and the noise level, surface roughness, or surface hardness. It has been experimentally grasped that the noise level is greatly affected by the surface treatment on the cylinder inner surface. The lower graph indicates the surface hardness represented in Shore hardness after the treatment, while a bar graph in the upper graph indicates the noise level when the pump is in operation, and a line graph in the upper graph indicates the average surface roughness after the treatment.

Ni—P plating coating makes the noise level lower than anodic oxide coating or PTFE coating does. Ni—P plating coating also makes the average surface roughness lower than anodic oxide coating or PTFE coating does. That is, anodic oxide coating or PTFE coating, which is high in noise level, indicates higher values in average surface roughness. Further, because there is no interrelation between the noise level and the surface hardness, it can be understood that noises are caused by the surface roughness of the coating.

In view of the above, in the practice of the present invention, a surface treatment to form Ni—P coating is conducted on the inner surface of the cylinder 6 to thereby prevent the production of rust. Because the Ni—P coating provides a smooth surface, sounds that would be produced from between the distal end surfaces of the vanes 12 and the inner surface of the cylinder 6 during rotation of the rotor 8 can be reduced.

In the above-described embodiment a lapping treatment is conducted on the inner surface of the cylinder 6 after the surface treatment by means of Ni—P coating. By so doing, the surface roughness is improved, making it possible to further reduce noises. The lapping treatment can be also conducted on the PTFE coating formed on the front plate 14 and the rear plate 16 or on the anodic oxide coating formed on the rotor 8 to improve the surface roughness so that noises can be effectively reduced.

1. An oil-free rotary vane air pump comprising:
a pump mechanism; and
a drive motor juxtaposed with the pump mechanism,
the pump mechanism comprising:
a cylinder having a cylindrical inner wall that is eccentric with respect to a longitudinal axis of the cylinder;
a cylindrical rotor accommodated within the cylinder and having a plurality of vane slits defined therein;
a rotary shaft that rotates together with the rotor;
a plurality of plate-shaped vanes made of a material having self-lubricating properties, each of the plurality of plate-shaped vanes being slidably received in one of the plurality of vane slits; and
a front plate and a rear plate mounted on opposite end surfaces of the cylinder, respectively, with the rotor and the vanes interposed therebetween, thereby forming a plurality of compression chambers in the pump mechanism;
wherein the rotary shaft is driven by the drive motor to change a volume of each of the compression chambers;
wherein a clearance is provided between the rotor and the front plate and between the rotor and the rear plate so as not to allow a sliding contact; and
wherein at least one of the cylinder, the rotor, the front plate, and the rear plate is made of a metal, and a surface treatment is conducted on a portion of such at least one of the cylinder, the rotor, the front plate, and the rear plate, which portion faces the compression chambers.

2. The rotary vane air pump according to claim 1, wherein the surface treatment is one or a combination of anodic oxide coating, Ni—P plating coating, and PTFE coating.

3. The rotary vane air pump according to claim 1, wherein the surface treatment is PTFE coating conducted on the front plate and the rear plate.

4. The rotary vane air pump according to claim 1, wherein the rotor is made of aluminum, and the surface treatment is anodic oxide coating conducted on the rotor.

5. The rotary vane air pump according to claim 1, wherein the surface treatment is Ni—P plating coating conducted on an inner surface of the cylinder.

6. The rotary vane air pump according to claim 1, wherein a lapping treatment is conducted on the portion of the at least one of the cylinder, the rotor, the front plate, and the rear plate, which portion has been conducted with the surface treatment.
